(19) United States
(12) Patent Application Publication
(10) Pub. No.: US 2007/0112589 A1
(43) Pub. Date: May 17, 2007

(54) User interface for providing assistance related to health

(75) Inventors: Edward K.Y. Jung, Bellevue, WA (US); Royce A. Levien, Lexington, MA (US); Robert W. Lord, Seattle, WA (US); Mark A. Malamud, Seattle, WA (US); John D. Rinaldo JR., Bellevue, WA (US); Lowell L. Wood JR., Livermore, CA (US)

Correspondence Address: SEARETE LLC;CLARENCE T. TEGREENE, 1756 - 114TH AVE., S.E., SUITE 110, BELLEVUE, WA, 98004, US

(73) Assignee: Searete LLC, a limited liability corporation of the State of Delaware

(21) Appl. No.: 11/285,753

(22) Filed: Nov. 22, 2005

Related U.S. Application Data
(63) Continuation-in-part of application No. 11/283,548, filed on Nov. 17, 2005.
(63) Continuation-in-part of application No. 11/285,500, filed on Nov. 22, 2005.

(51) Int. Cl. G06Q 10/00; G06F 7/00; G06F 3/00

(52) U.S. Cl. 705/2; 715/700; 707/102

(57) ABSTRACT

In one aspect, a method related to health-related data management. In addition to the foregoing, other method and system and program product aspects are described in the claims, drawings, and text forming a part of the present application.

### CROSS-REFERENCE TO RELATED APPLICATIONS

The present application is related to, claims the earliest available effective filing date(s) from (e.g., claims earliest available priority dates for other than provisional patent applications; claims benefits under 35 USC § 119(e) for provisional patent applications), and incorporates by reference in its entirety all subject matter of the following listed application(s) (the “Related Applications”) to the extent such subject matter is not inconsistent herewith; the present application also claims the earliest available effective filing date(s) from, and also incorporates by reference in its entirety all subject matter of any and all parent, grandparent, great-grandparent, etc. applications of the Related Application(s) to the extent such subject matter is not inconsistent herewith. The United States Patent Office (USPTO) has published a notice to the effect that the USPTO's computer programs require that patent applicants reference both a serial number and indicate whether an application is a continuation or continuation in part. Stephen G. Kunin, Benefit of Prior-Filed Application, USPTO Electronic Official Gazette, Mar. 18, 2003 at http://www.uspto.gov/web/offices/com/sol/og/2003/week 11/patbene.htm. The present applicant entity has provided below a specific reference to the application(s)from which priority is being claimed as recited by statute. Applicant entity understands that the statute is unambiguous in its specific reference language and does not require either a serial number or any characterization such as “continuation” or “continuation-in-part.” Notwithstanding the foregoing, applicant entity understands that the USPTO's computer programs have certain data entry requirements, and hence applicant entity is designating the present application as a continuation in part of its parent applications, but expressly points out that such designations are not to be construed in any way as any type of commentary and/or admission as to whether or not the present application contains any new matter in addition to the matter of its parent application(s).

### RELATED APPLICATIONS

1. For purposes of the USPTO extra-statutory requirements, the present application constitutes a continuation in part of currently co-pending United States patent application entitled Providing Assistance Related to Health, naming Edward K. Y. Jung, Royce A. Levien, Robert W. Lord, Mark A. Malamud, John D. Rinaldo, Jr., and Lowell L. Wood, Jr., as inventors, USAN: To be Assigned, filed Nov. 17, 2005.
2. For purposes of the USPTO extra-statutory requirements, the present application constitutes a continuation in part of currently co-pending United States patent application entitled User Interface for Providing Assistance Related to Health, naming Edward K. Y. Jung, Royce A. Levien, Robert W. Lord, Mark A. Malamud, John D. Rinaldo, Jr., and Lowell L. Wood, Jr., as inventors, USAN: To be Assigned, filed Nov. 22, 2005, contemporaneously herewith.

### TECHNICAL FIELD

The present application relates, in general, to health-related data management.

### SUMMARY

In one aspect, a method related to health-related data management includes but is not limited to providing an interface to enable an end-user to change one or more health regimen data entities; and accepting input to the interface. In addition to the foregoing, other method aspects are described in the claims, drawings, and text forming a part of the present application.

In one aspect, a system related to health-related data management includes but is not limited to circuitry for providing an interface to enable an end-user to change one or more health regimen data entities; and circuitry for accepting input to the interface. In addition to the foregoing, other system aspects are described in the claims, drawings, and text forming a part of the present application.

In one or more various aspects, related systems include but are not limited to circuitry and/or programming and/or electromechanical devices and/or optical devices for effecting the herein-referenced method aspects; the circuitry and/or programming and/or electro-mechanical devices and/or optical devices can be virtually any combination of hardware, software, and/or firmware configured to effect the herein referenced method aspects depending upon the design choices of the system designer skilled in the art.

In one aspect, a program product includes but is not limited to a signal bearing medium bearing one or more instructions for providing an interface to enable an end-user to change one or more health regimen data entities; and one or more instructions for accepting input to the interface. In addition to the foregoing, other program product aspects are described in the claims, drawings, and text forming a part of the present application.

In addition to the foregoing, various other method, system, and/or program product aspects are set forth and described in the teachings such as the text (e.g., claims and/or detailed description) and/or drawings of the present application.

The foregoing is a summary and thus contains, by necessity, simplifications, generalizations and omissions of detail; consequently, those skilled in the art will appreciate that the summary is illustrative only and is NOT intended to be in any way limiting. Other aspects, features, and advantages of the devices and/or processes and/or other subject matter described herein will become apparent in the teachings set forth herein.

### BRIEF DESCRIPTION OF THE FIGURES

FIG. 1 depicts one implementation of an exemplary environment in which the methods and systems described herein may be represented;

FIG. 2 depicts alternative exemplary embodiments;

FIG. 3 illustrates alternative exemplary embodiments;

FIG. 4 illustrates alternative exemplary embodiments;

FIG. 5 depicts alternative exemplary aspects of embodiments;

FIG. 6 depicts an exemplary view of aspects of an embodiment;

FIG. 7 depicts an alternative exemplary view of the aspects of the embodiment depicted in FIG. 6;

FIG. 8 depicts an exemplary view of aspects of an embodiment;

FIG. 9 depicts an alternative exemplary view of the aspects of the embodiment depicted in FIG. 8;

FIG. 10 depicts an exemplary view of aspects of an embodiment.

FIG. 11 depicts an alternative exemplary view of aspects of the embodiment depicted in FIG. 10;

FIG. 12 depicts a high-level logic flowchart of an operational process;

FIG. 13 shows several alternative implementations of the high-level logic flowchart of FIG. 12;

FIG. 14 shows several alternative implementations of the high-level logic flowchart of FIG. 13; and

FIG. 15 shows several alternative implementations of the high-level logic flowchart of FIG. 12.

The use of the same symbols in different drawings typically indicates similar or identical items.

### DETAILED DESCRIPTION

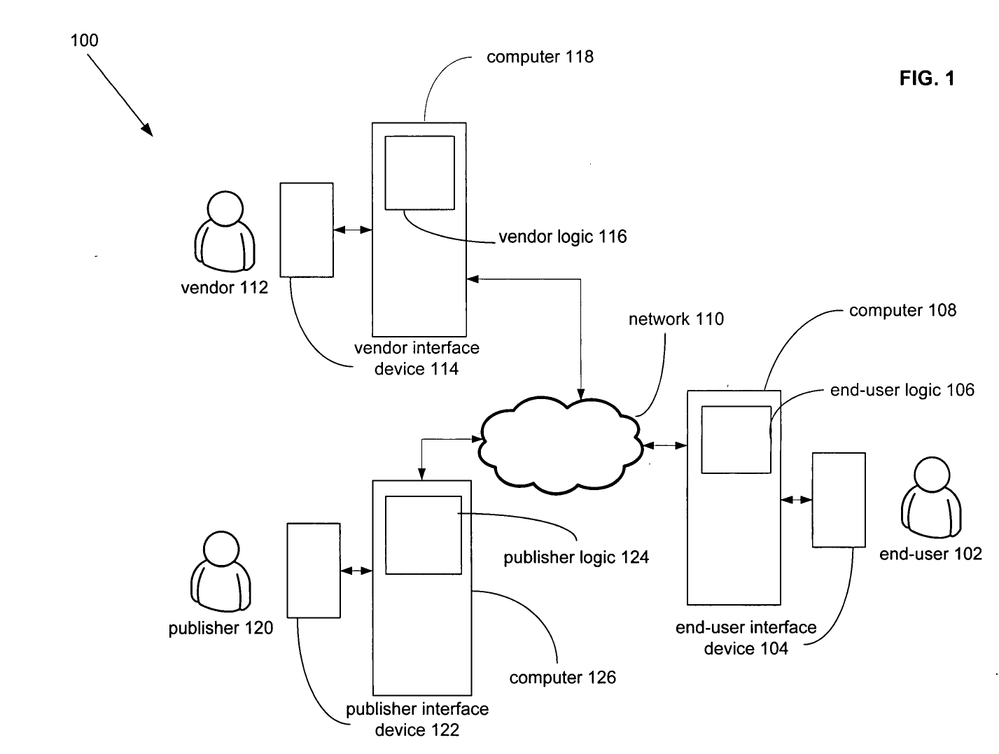

FIG. 1 illustrates an exemplary environment 100 in which embodiments may be used. The end-user 102 is a person who wishes to access information regarding pharmaceutical, nutraceutical, veterinary, dietary, and/or nutritional substances, procedures, processes, and/or practices of interest. The end-user interface device 104 may be a keyboard, mouse, trackball, monitor, microphone and speakers, and/or other interface device or devices for a human to interface with the end-user logic 106 of computer 108. The end-user logic 106 may include at least a portion of the hardware/software/firmware of the computer 108. The computer 108 may be used by the end-user 102 to access such information via another computer or computers represented by the network 110.

Vendor 112 is a person and/or persons and/or entity and/or entities that may supply pharmaceutical, nutraceutical, veterinary, dietary, and/or nutritional substances, procedures, processes, and/or practices of interest. The vendor interface device 114 may be a keyboard, mouse, trackball, monitor, microphone and speakers, and/or other interface device or devices for a human to interface with the vendor logic 116 of computer 118. The vendor logic 116 may include at least a portion of the hardware/software/firmware of the computer 118. The vendor 112 may use the computer 118 to provide information and channels, making the vendor 112 available to provide pharmaceutical, nutraceutical, veterinary, dietary, and/or nutritional substance, procedure, processes, and/or practices of interest, via another computer or computers represented by the network 110, to, among others, the end-user 102.

Publisher 120 is a person and/or persons and/or entity and/or entities that may supply information about pharmaceutical, nutraceutical, veterinary, dietary, and/or nutritional substances procedures, processes, and/or practices of interest, and/or about authorities having expertise or claimed expertise regarding pharmaceutical, nutraceutical, veterinary, dietary, and/or nutritional substances procedures, processes, and/or practices of interest. The publisher interface device 122 may be a keyboard, mouse, trackball, monitor, microphone and speakers, and/or other interface device or devices for a human to interface with the publisher logic 124 of computer 126. The publisher logic 124 may include at least a portion of the hardware/software/firmware of the computer 126. The publisher 120 may use the computer 126 to provide such information about pharmaceutical, nutraceutical, veterinary, dietary, and/or nutritional substance, procedure, processes, and/or practices of interest, via another computer or computers represented by the network 110, to, among others, the end-user 102. The publisher 120 represents a wide variety of information providers, including but not limited to magazine publishers, book publishers, website maintainers, weblog proprietors, experts, research organizations, and users of the pharmaceutical, nutraceutical, veterinary, dietary, and/or nutritional substances procedures, processes, and/or practices of interest.

End-users 102, vendors 112, and publishers 120 are not mutually exclusive categories. One person, group of persons, entity, or group of entities may be categorized as an end-user 102, vendor 112, and/or publisher 120 simultaneously or at different times. End-users 102, vendors 112, and publishers 120 are exemplary parties and do not represent all users. Exemplary descriptions including the end-user 102 are not limiting and do not preclude use of an embodiment by vendors 112 and/or publishers 120.

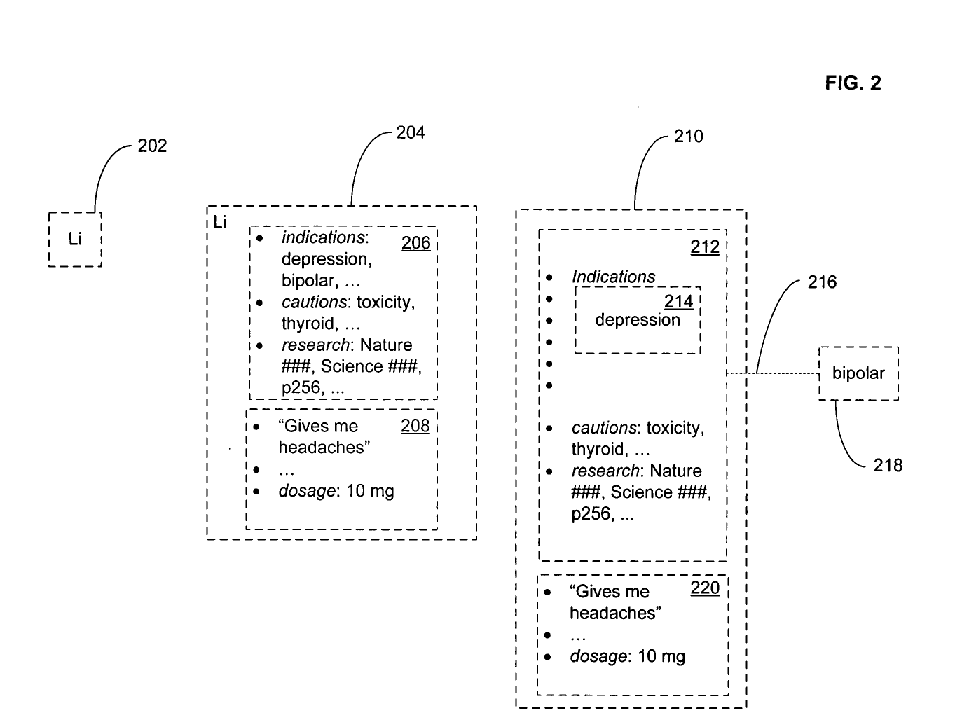

FIG. 2 depicts alternative exemplary embodiments of a data entity, including depiction of alternative exemplary embodiments of health regimen data entities associated with some amount of additional information. This additional information may include but is not limited to an item of associative information, e.g., a linkage or a resolvable reference, to one or more other health regimen data entities in the data structure/data structures (e.g., which may be distributed data structures), e.g., a pointer, identifier, and/or a link. In FIG. 2 and the other figures, items of associative data are depicted by lines and/or arrows between health regimen data entities, or are implicit of the relationship between a nesting health regimen data entity and any health regimen data entity nested within or at any depth; such implicit items of associative data are shown by the illustrated nesting. The additional information may also include but is not limited to substantive information, e.g., where the health regimen data entity includes the identity of a substance and the additional information describes a potential use or specifies a dosage. Here health regimen data entity 202 includes an identifier for the element lithium (Li). The health regimen data entity 204 illustrates an alternative exemplary embodiment of the health regimen data entity 202. The end-user 102 may select the health regimen data entity 202 to access additional information that is included in association with the health regimen data entity 202. The additional information may be organized in some defined way, as illustrated in organizational structure 206, or unorganized as in collection 208. The health regimen data entity 210 shows another alternative exemplary embodiment of the health regimen data entity 202. Here the additional information is illustrated as being included in an organizational structure 212. One of the items of additional information associated with the organizational structure 212 is depicted as another health regimen data entity 214 “nested” within health regimen data entity 212. Another of the items of additional information associated with the health regimen data entity 212 is linked by an item of associative information 216 to another health regimen data entity 218. Organizational principles such as those illustrated by the relationship between health regimen data entity 212 and health regimen data entity 214, and by the relationship between health regimen data entity 212, item of associative information 216, and health regimen data entity 218, may be replicated at any level of an organizational structure, or in an unorganized collection such as collection 220. It is to be understood that in substantially all examples referring to “an identifier for lithium” herein, analogous examples utilizing the alternatives such as those from FIG. 2, will be recognized by those of skill in the art. Such examples are not expressly set forth herein for the sake of clarity.

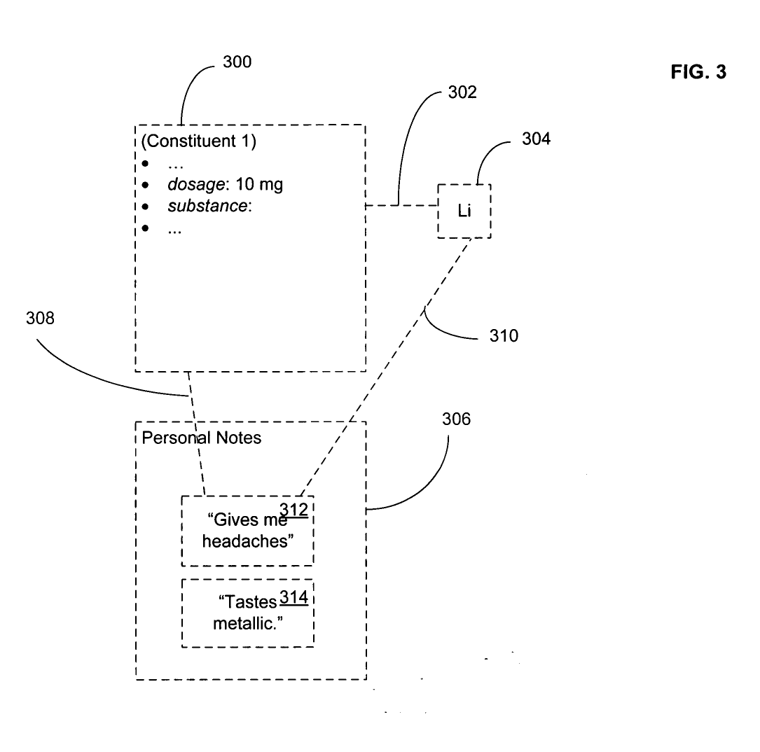

FIG. 3 illustrates an alternative exemplary embodiment of a health regimen data entity. Depicted is nesting health regimen data entity 300, which includes additional information relevant in the context of the nesting health regimen data entity 300, here, “constituent 1.” The identity of constituent 1 is not nested within nesting health regimen data entity, but an item of associative data 302 links to a health regimen data entity 304 identifying lithium (“Li”). Also illustrated is a health regimen data entity 306 having additional information detailing personal notes from users of constituent 1. Shown are nested health regimen data entity 312 and 314. The health regimen data entity 312 is linked to the nesting health regimen data entity 300 by an item of associative data 308 and to the health regimen data entity 304 by an item of associative data 310.

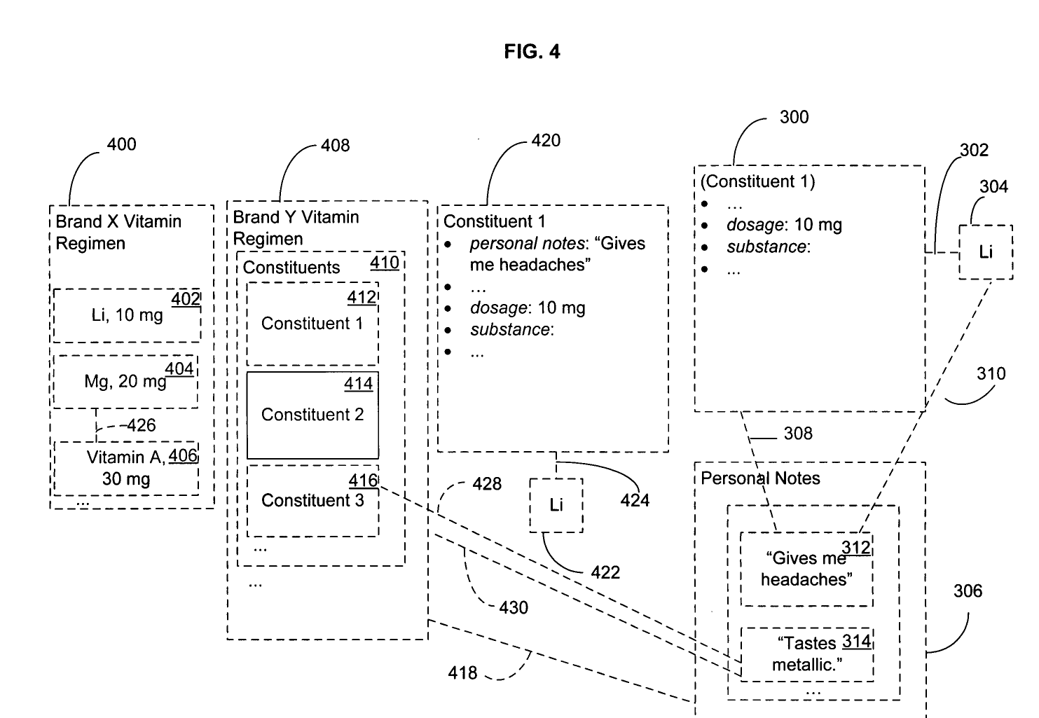

FIG. 4 illustrates a number of alternative exemplary health regimen data entities organized in the data structure according to different organizational schemes. Shown is nesting health regimen data entity 400, including three nested health regimen data entities 402, 404, and 406, for three components of a “Brand X” vitamin regimen. Depicted is nesting health regimen data entity 408, including a nested and nesting health regimen data entity 410. Nested and nesting health regimen data entity 410 includes nested health regimen data entities 412, 414, and 416, components of a “Brand Y” vitamin regimen. Illustrated is nesting health regimen data entity 408 associated with health regimen data entity 306 with an item of associative data 418, linking the personal notes of health regimen data entity 306 with the “Brand Y” vitamin regimen of nesting health regimen data entity 408. Illustrated is health regimen data entity 420, pertaining to “constituent 1,” including additional information about personal notes, dosage, and substances. The health regimen data entity 420 is shown linked to health regimen data entity 422, identifying Lithium, by an item of associative data 424. The health regimen data entity 406 is shown linked to another health regimen data entity 404 by an item of associative data 426. The health regimen data entity 314 is shown linked to the health regimen data entity 416 by an item of associative data 428. The health regimen data entity 314 is also shown linked to health regimen data entity 416 by an item of associative data 430.

The nesting as illustrated in FIGS. 2, 3, and 4 is accomplished with items of associative information that are associated with either the nesting health regimen data entity or with one or more of the illustrated nested health regimen data entities. The nesting health regimen data entity might represent, e.g., the name of a vitamin supplement, and the nested health regimen data entities might represent, e.g., five constituent supplements comprised by the named vitamin supplement. In another example, the nesting health regimen data entities might represent identifiers of taxonomic classifications to which the constituent belongs, such as chemical classes (such as water soluble or fat soluble vitamins), classes of effect or action (such as beta-blockers, neurotransmitters, or strength enhancers).

A health regimen data entity may be associated with another health regimen data entity in a variety of ways. The first health regimen data entity may be associated with the second health regimen data entity with an item of associative information associated with one or the other or both. The first health regimen data entity may be associated with the second health regimen data entity as well as with additional health regimen data entities simultaneously. The multiply-referenced health regimen data entity may actually be multiple health regimen data entities in the data structure, or it may be a single health regimen data entity with multiple items of associative information used to reference it.

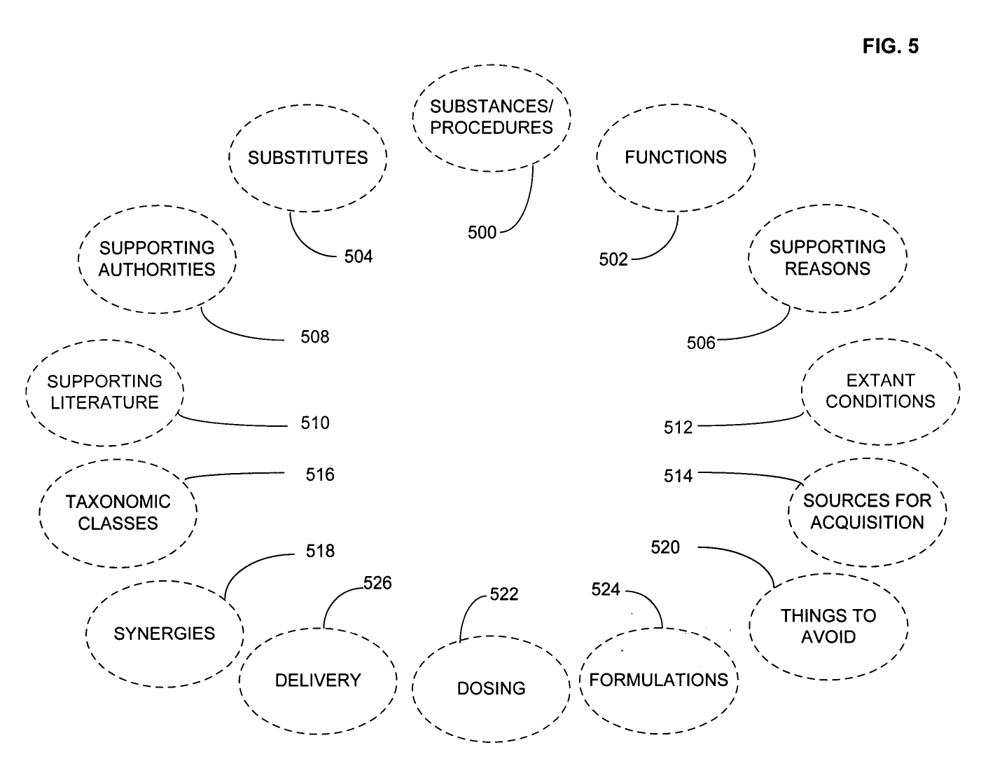

FIG. 5 depicts a number of alternative exemplary topics which may be used in the data structure. The identity of a topic may be represented by a health regimen data entity, and association with a topic accomplished by use of an item of associative information. At least some health regimen data entities may be associated with topics of interest to the end-user 102 to provide a schema with which to begin use of the information in the data structure. Each of the topics is exemplary, but they serve to illustrate a particular application which is not limiting. An end-user 102 may start retrieving data from the data structure by starting with any topic in the data structure. Each item of data stored in association with each topic may have associated using an item of associative information with another item of data associated with the same topic or with another topic, such that an end-user 102 starting with an item of data in a particular topic, e.g., a name of Substance A under the topic Substances/Procedures, may choose to retrieve another item of data associated with Substance A via a an item of associative information to a health regimen data entity associated with another topic, e.g., a function of Substance A, relief of joint pain, associated with the topic Functions. The end-user 102 may continue by selecting an item of data associated with a third topic, e.g., a Substitute B for Substance A for the relief of joint pain, associated with the topic Substitutes. The end-user 102 may continue in this fashion through all of the data items in the topics in the data structure associated via items of associative information to the selections of the end-user 102.

Although shown for clarity in FIG. 5 as discrete topics, generally, topics may be associated with or even be composed of other topics, and a given topic or reference to that topic may be associated with another discrete topic.

The topic 500, “Substances/Procedures,” may include common, generic, commercial, and/or trade names and/or descriptions for pharmaceutical, nutraceutical, veterinary, dietary, and/or nutritional substances, procedures, processes, and/or practices of interest to an end-user 102.

The topic 502, “Functions,” may include one or more descriptions of functions for which the substances of the topic 500, “Substances/Procedures” may be used by humans in connection with human physical and/or mental conditions, and/or veterinary purposes.

The topic 504, “Substitutes,” may include common, generic, commercial, and/or trade names and/or descriptions for pharmaceutical, nutraceutical, veterinary, dietary, and/or nutritional substances, procedures, processes, and/or practices of interest to an end-user 102, which may be substituted to perform functions associated with the topic 502, “Functions.”

The topic 506 “Supporting Reasons,” may include explanations for the functionality of the substances/procedures and substitutes included in the topics 500, “Substances/Procedures” and 504, “Substitutes.”

The topic 508, “Supporting Authorities,” may include the identities and credentials of people and/or entities which endorse the use of substances/procedures and substitutes for various functions. The supporting authorities may include medical and/or veterinary professionals and/or experts of various kinds (“gurus”), and/or manufacturers and/or distributors of substances/procedures and substitutes. The topic 508, “Supporting Authorities,” may also include testimonials and/or reports and/or anecdotal evidence from other end-users 102, and may include descriptors of factors associated with those end-users 102 to permit manual or automatic correlation of their experience with the potential experience of the end-user 102 consulting the data structure.

The topic 510, “Supporting Literature,” may include references to published articles and/or other publicly available information, by citation and/or hyperlink and/or other reference means, e.g., referred journal articles and/or magazine articles and/or website articles, pertaining to the functionality of substances/procedures and substitutes.

The topic 512, “Extant Conditions,” may include one or more selections of descriptors that describe internal physical and/or mental and/or environmental and/or spiritual and/or metaphysical factors of interest to the end-user 102 and of possible relevance to the functionality of substances/procedures and substitutes. Internal physical factors may include body temperature, medical condition, genetic information, and/or substances/procedures or substitutes ingested or to be ingested. Mental factors may include a diagnosed mental condition, a subjective mental state, genetic information, and/or substances/procedures or substitutes ingested or to be ingested. Environmental factors may include external temperature, humidity, barometric pressure, ambient light intensity, and, for some, the date, the positions of the planets, geographical factors such as those relevant tofeng shui, and/or other factors relevant to disciplines, traditions, and arts considered relevant by the end-user 102 and/or by a contributor of information to the data structure and/or by a third-party authority such as an expert or a source for acquisition. Where feasible, values for external factors may be provided to the data structure in the form of health regimen data entities representing the output of instrumentation, e.g., weather instrumentation or medical instrumentation.

The topic 514, “Sources for Acquisition,” may include identities of, contact information for, and/or channels of communication with persons and/or entities from which substances/procedures or substitutes may be purchased or otherwise acquired by the end-user 102. Such sources may pay to be included in the data structure in association with this topic.

The topic 516, “Taxonomic Classes,” may include various categories with which substances/procedures and/or substitutes may be associated, e.g. acids, derivatives from X, etc.

The topic 518, “Synergies,” may include substances/procedures, substitutes, activities, and/or extant conditions that, acting together with a substance or substitute, enhance the functionality of the substance or substitute; favorably change the amount or timing or the substance or substitute needed for the desired functionality; and/or provide one or more additional desirable functionalities beyond those associated with the substance or substitute taken by itself.

The topic 520, “Things to Avoid,” may include substances/procedures, substitutes, activities, and/or extant conditions that, acting together with a substance or substitute, detracts from the functionality of the substance or substitute; unfavorably changes the amount or timing or the substance or substitute needed for the desired functionality; and/or provides one or more additional undesirable functionalities beyond those associated with the substance or substitute taken by itself.

The topic 522, “Dosing,” may include information pertaining to the mode, amount, conditions, and/or timing of the delivery of a substance or substitute to achieve the desired functionality, along with synergies and things to avoid, e.g., 200 mg capsules of Substance A, taken twice daily when sunny and thrice daily when cloudy or raining; or once daily under any conditions no matter the weather, and never to be taken when Substance B has been taken within 24 hours. Beyond that simple example, the topic 522, “Dosing,” may include a procedure for determining an amount and/or timing for the substance to be taken, rather than a simple fixed value, along with factors that give the end-user 102 options based on probabilities and other factors such as extant conditions, e.g., when the weather is hot and the end-user 102 is feeling irritable, an option to reduce a lithium dose by one pill per day, and if that does not work, by two pills per day, but never by more than two pills per day. These options and alternatives to them may also be accessed by associations with other health regimen data entities, including, e.g., hot days, lithium, and/or irritability.

The topic 524, “Formulations,” may include information pertaining to the constituents of a substance, including but not limited to the identities of the constituents, the amounts of the constituents present per unit of the substance, and/or the method(s) for combining the constituents to form the substance. In particular, the amounts of the constituents may be represented by listing the amounts numerically, and/or by a formula or formulas from which each constituent amount may be derived either by the end-user 102 or by computational resources associated with the data structure. In an embodiment, the end-user 102 may follow items of associative information to health regimen data entities and/or additional information that provide information on the sources of formulary information, e.g., an article on an experiment, or on the instruments that provided the formulary information, e.g., an indication of what the underlying methodology of selection is at least partially based upon (e.g., animal studies, human studies, in silico studies, speculation, anecdotal information, historical accounts, traditions, cultural practices, native practices, etc.

The topic 526, “Delivery,” may include information on methods of delivery, e.g., orally by capsule, orally by liquid dose, epidermally by patch, injection by syringe, and/or internally by timed release from an implanted reservoir, and on formulations, dose sizes, and dose timings associated with various delivery methods.

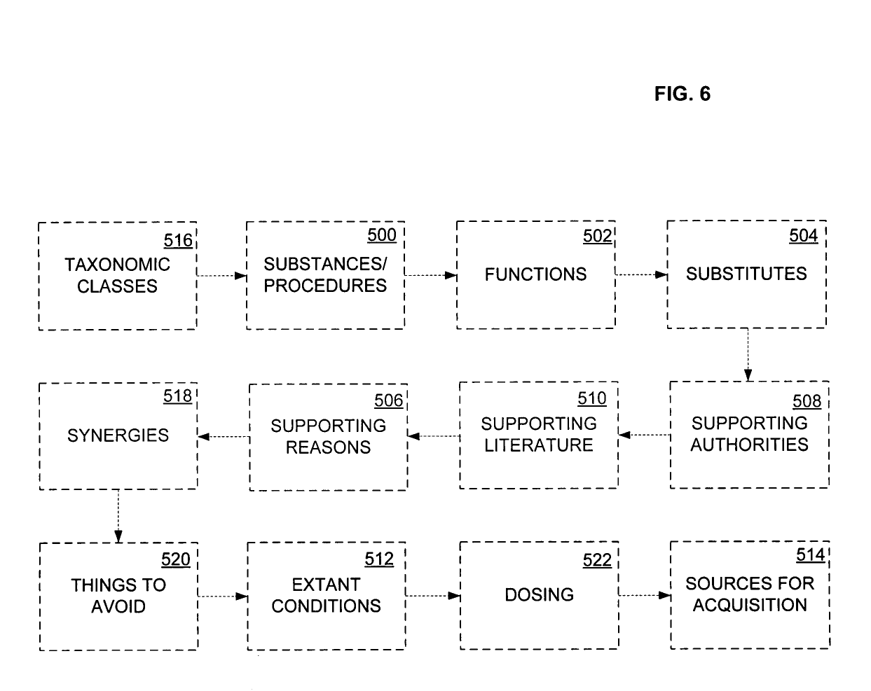

FIG. 6 depicts an exemplary way to view a pathway of an end-user 102 through data in the data structure. The end-user 102 in this exemplary view starts with taxonomic classes, e.g. vitamins, selects a vitamin, e.g., Vitamin X, and selects an associated function, e.g., increased energy. The end-user 102 finds a substitute for Vitamin X for increasing energy, e.g., Substance Y, refers to supporting authorities, e.g., a particular columnist for a magazine, supporting literature, e.g., an article in JAMA, and supporting reasons, e.g., a web-based explanation for the effects of Substance Y on energy. From there, the end-user 102 calls up information on synergies, e.g., Substance Z as being synergistic with Substance Y, providing increased memory when they are used together, along with things to avoid, e.g., not using Substance W in conjunction with Substance X because such conjunctive use causes impotence. The end-user 102 may consult “Extant Conditions” to learn that Substance X has an increased effect at lower altitudes and/or when certain planets are in a particular astrological configuration. The end-user 102 may consult the “Dosing” topic for information on dosing under various conditions, and she may peruse sources for acquisition to select a mode of purchase, to conclude the purchase, and to arrange for delivery.

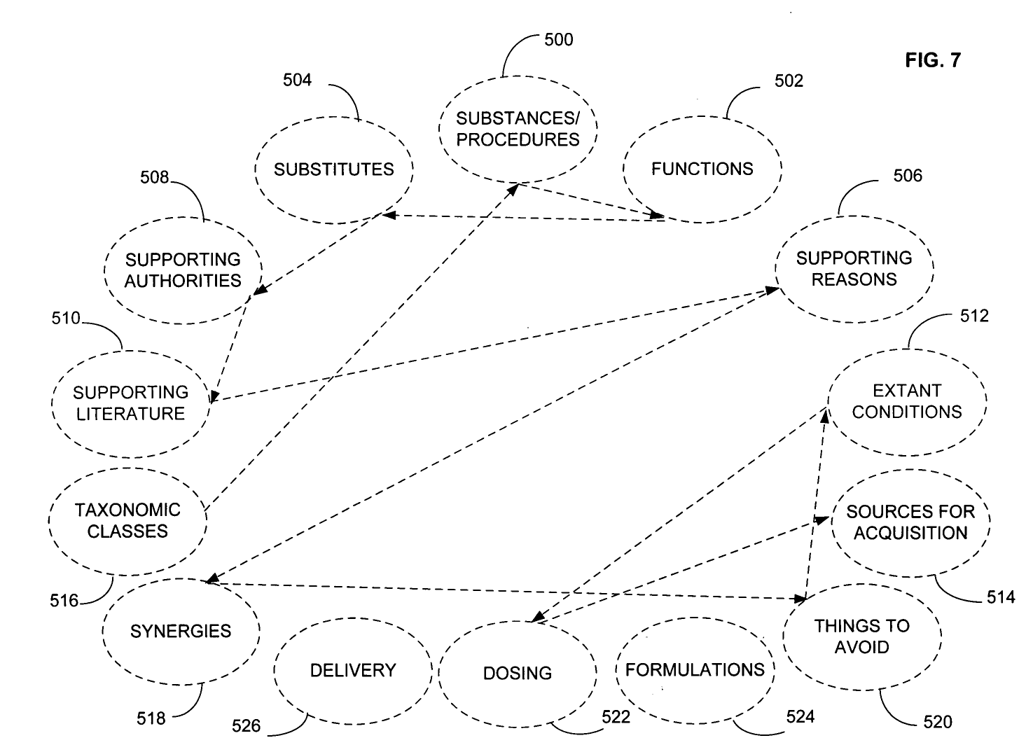

FIG. 7 depicts an alternative exemplary way to view the pathway of an end-user 102 through data in the data structure depicted in FIG. 6, using as a template the depiction of FIG. 5.

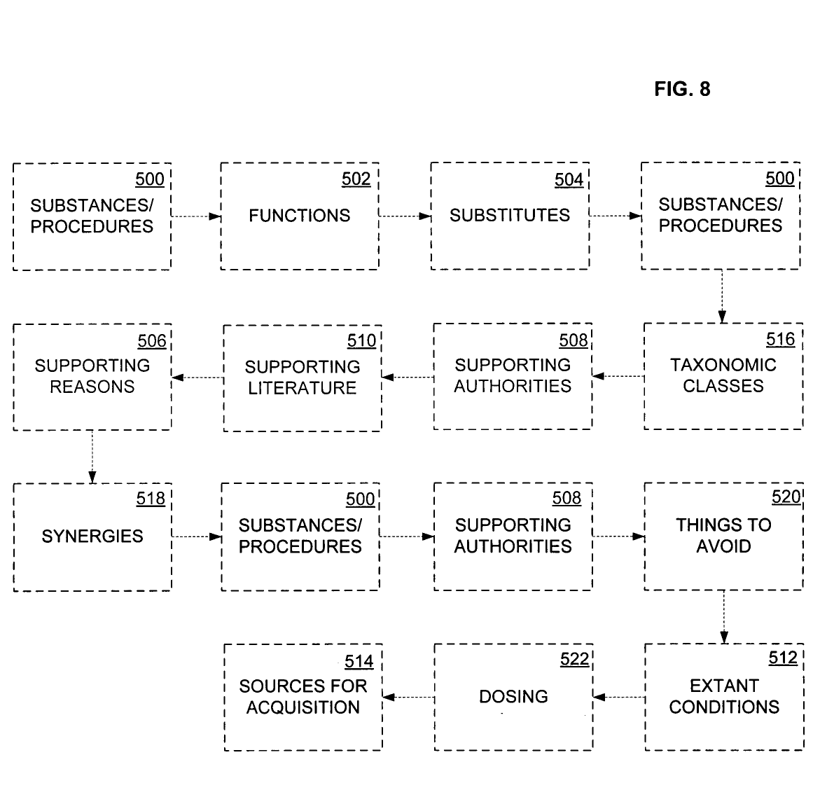

FIG. 8 depicts an exemplary view of the pathway of an end-user 102 through data in the data structure. The end-user 102 starts with a substance, e.g., Substance M, and looks up functions for Substance M, e.g., protection against cancer. The end-user 102 then looks up substitutes for Substance M for protection against cancer, e.g., Substance N. The end-user 102 then becomes interested in Substance N for other purposes. Going back to the topic “Substances/Procedures” to learn about Substance N, the end-user 102 learns that Substance N is a member of a particular taxonomic class, e.g. acids. The end-user 102 reassures himself of the efficacy of Substance N for some other purpose, e.g., prevention of hair loss, by consulting a supporting authority, e.g., a famous cancer researcher, supporting literature, e.g., a Scientific American article, and supporting reasons, e.g., a published explanation of why Substance N prevents hair loss. The end-user 102 retrieves information on synergies from the use of Substance N and Substance O, e.g., enhanced prevention of hair loss and fresher breath, and on things to avoid, e.g., the use of Substance N with, e.g., Substance P, which would lead to decreased efficacy for hair loss and extensive skin rashes. The end-user 102 calls up the effects of extant conditions on the use of Substance N, e.g., amplification of any already-present schizophrenia when certain planets are in a particular astrological configuration. The end-user 102 finishes by retrieving dosing information and proceeding to purchase through a source for acquisition.

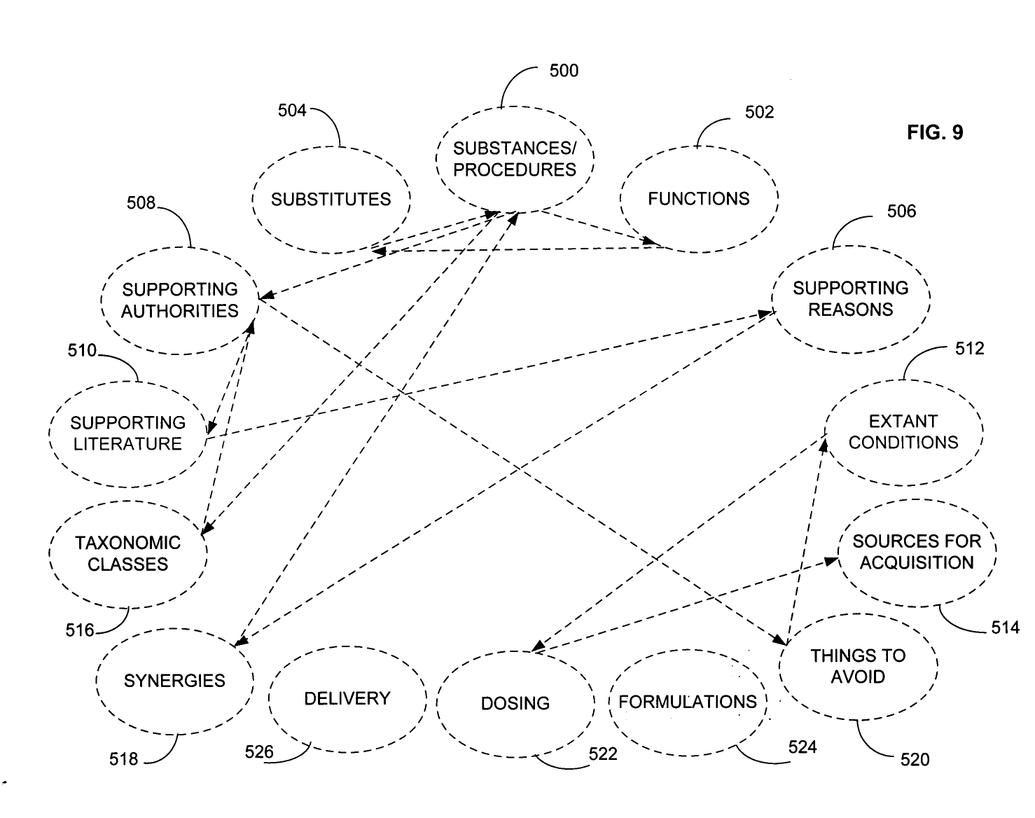

FIG. 9 depicts an alternative exemplary way to view the pathway of an end-user 102 through data in the data structure depicted in FIG. 8, using as a template the depiction of FIG. 5.

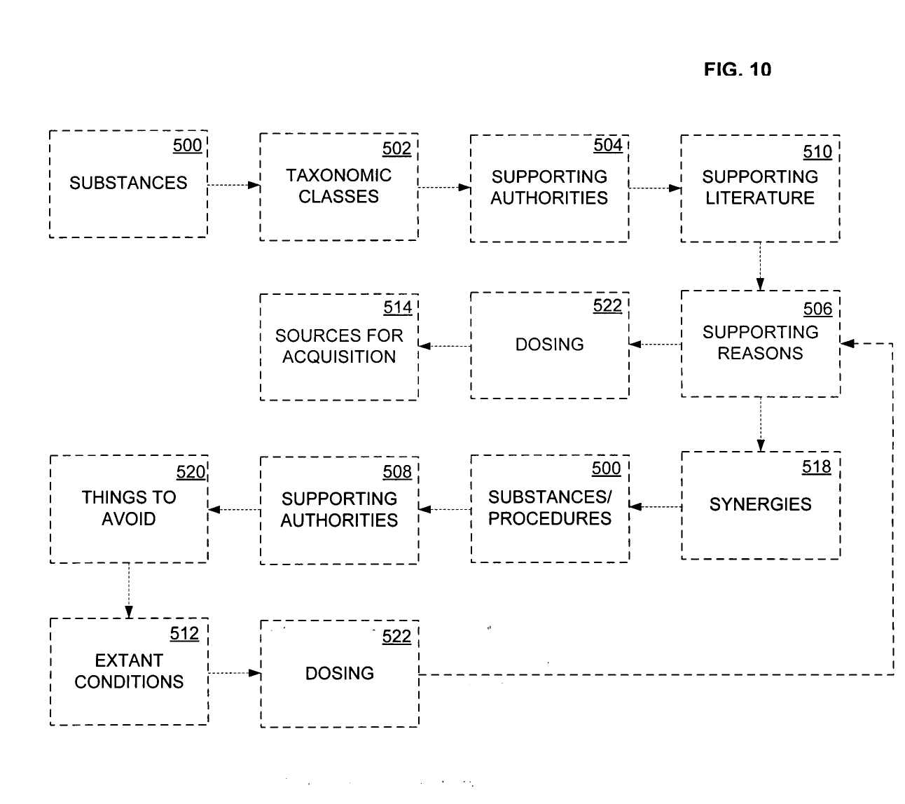

FIG. 10 depicts an exemplary way to view a branched pathway of an end-user 102 through data in the data structure. The end-user starts with a substance, e.g., Substance P, and looks up taxonomic classes associated with for Substance P, e.g., water soluble vitamins. The end-user 102 then looks up supporting authorities for the use of water soluble vitamins for protection against cancer, such as a columnist in a well-known health magazine, and moves on to supporting literature, e.g., articles in reference journals, and supporting reasons, e.g., explanations of the functionality of water soluble vitamins for prevention of cancer. At this point, the end-user 102 remembers that a friend had been asking about the use of water soluble vitamins for other purposes, such as prevention of hair loss, especially in combination with certain procedures for their use. Leaving aside his original search, the end-user 102 takes up his friend's question and looks up synergies with regard to water soluble vitamins. After perusing synergies, he selects a procedure, e.g., taking a particular water soluble vitamin in conjunction with a food such as a particular fruit. He looks up supporting authorities for the efficacy of the water soluble vitamin in conjunction with the fruit for preventing hair loss, e.g., a medical society. He then checks for things to avoid, such as the use of a second vitamin that would reduce the effectiveness of the first vitamin and the fruit, and extant conditions, such as humidity, which might affect the usefulness of the water soluble vitamin. Finally, he looks at the appropriate dosing for the water soluble vitamin. Having investigated his friend's question, he returns to his original search. He had been looking up supporting reasons for the use of water soluble vitamins to prevent cancer. He resumes his research at that point and moves on to investigate appropriate dosing. Finally, he moves to sources for acquisition of the Substance P.

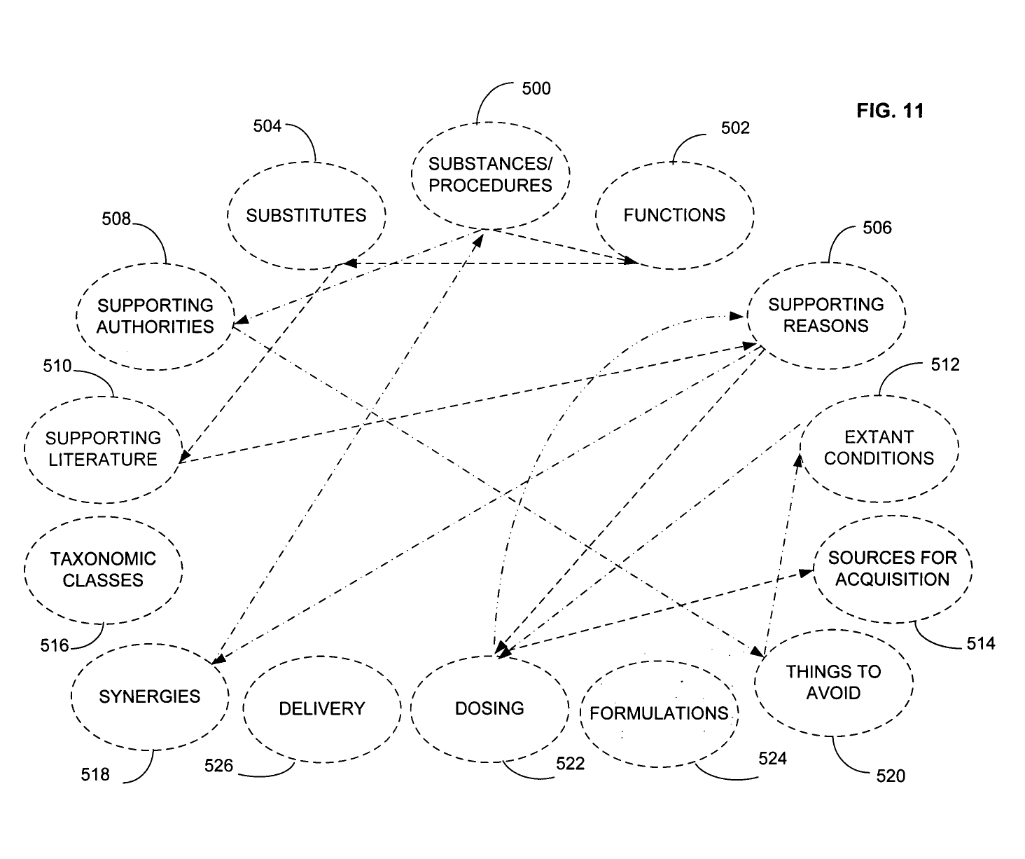

FIG. 11 depicts an alternative exemplary way to view the pathway of an end-user 102 through data in the data structure depicted in FIG. 10, using as a template the depiction of FIG. 5.

The end-user 102 may search the data structure for patterns, finding correlations between health regimen data entities that would otherwise not be discoverable or that would be very difficult to discover. For example, the end-user 102 may search for effects of Substance A on skin rashes in conditions of high humidity, searching, among other health regimen data entities, those including anecdotal evidence from users of Substance A in high humidity, where the users of Substance A also had skin rashes and reported apparent effects of Substance A on those rashes. Such searches for correlations may include information and observations added to the data structure by all or any of the end-users 102, vendors 112, and/or publishers 120 using the data structure. Such searches may be used to test hypotheses about the efficacy and safety of pharmaceutical, nutraceutical, veterinary, dietary, and/or nutritional substances, procedures, processes, and/or practices of interest.

As mentioned above, end-users 102 may add health regimen data entities to the data structure to report experiences with the use of substances/procedures. For example, an end-user 102 may integrate a report of an experience, e.g., partial success with the use of Substance B for reduction of hair loss in low-humidity conditions but little success in conditions of high-humidity, by selecting pre-existing health regimen data entities with which to associate new health regimen data entities that represent relevant elements of his report, and/or by associating new health regimen data entities that represent relevant elements of his report with pre-existing annotations to pre-existing health regimen data entities added by other end-users 102 with similar reports. An end-user 102 may also add health regimen data entities representing the results of correlative searches such as those described above, e.g., by adding health regimen data entities representing the results of such a search and associating them with pre-existing health regimen data entities associated with, e.g., a Substance C used to alleviate heartburn in connection with particular dietary conditions.

In using the data structure, the end-user 102 may impose his own schema on the information searched and on the output of the search. The end-user 102 may explicitly include or exclude for search purposes health regimen data entities representing factors such as weather information or astrological information. He may include or exclude for search results reporting purposes various complexities, e.g., including tables of correlations for further study, but excluding such information and including only lists of ingredients and instructions for purposes of making a particular substance for use or lists of dosages to serve as input into medical dispensing devices, either indirectly through human input to devices or automatically through direct input of dosage information to devices.

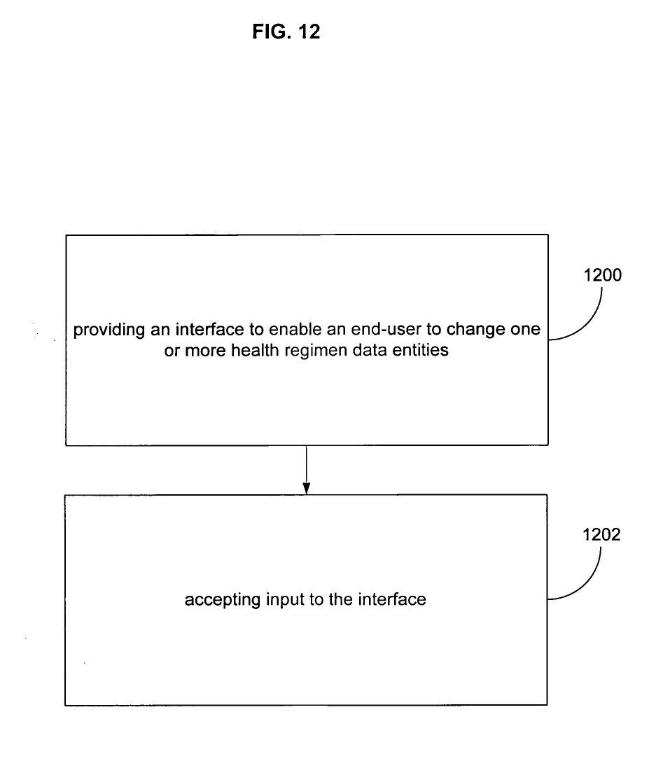

FIG. 12 depicts a high-level logic flowchart of an operational process. Operation 1200 shows providing an interface to enable an end-user to change one or more health regimen data entities (e.g., providing an interface via the end-user interface device 104, using the end-user logic 106, to add and/or delete and/or alter a health regimen data entity that is part of a data structure stored at least in part on the computer 108). Operation 1202 depicts accepting input to the interface (e.g., accepting input to interface via the end-user interface device 104, using the end-user logic 106, to add and/or delete and/or alter a health regimen data entity that is part of a data structure stored at least in part on the computer 108).

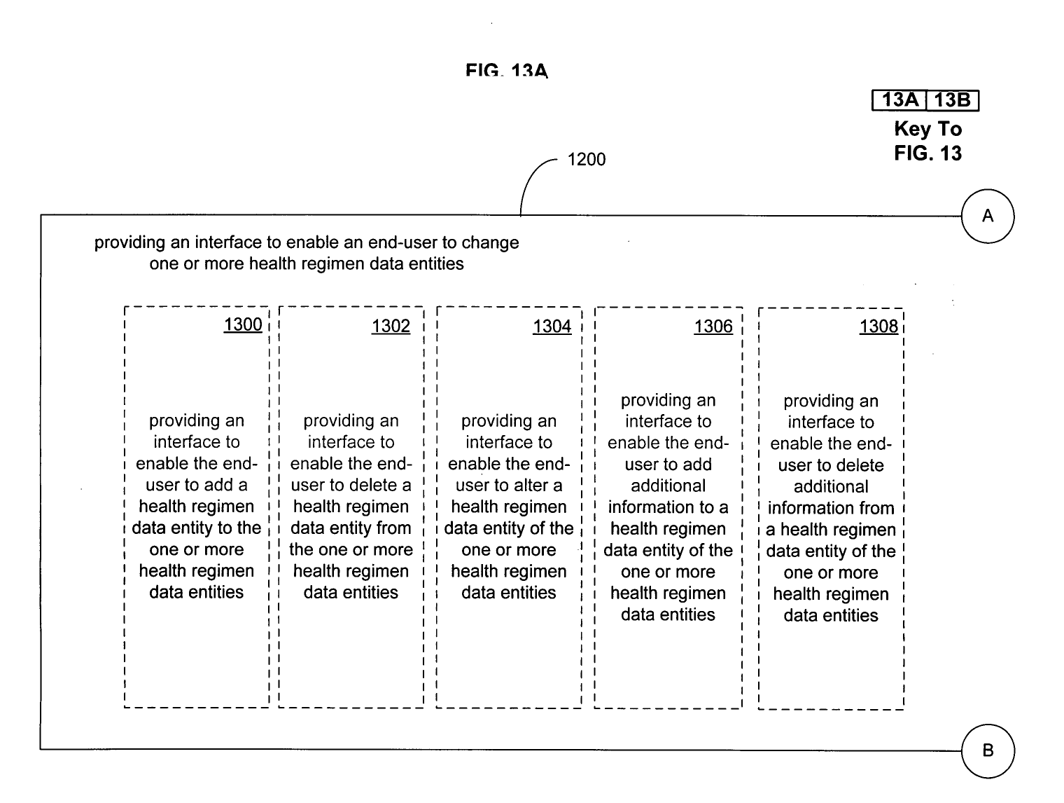

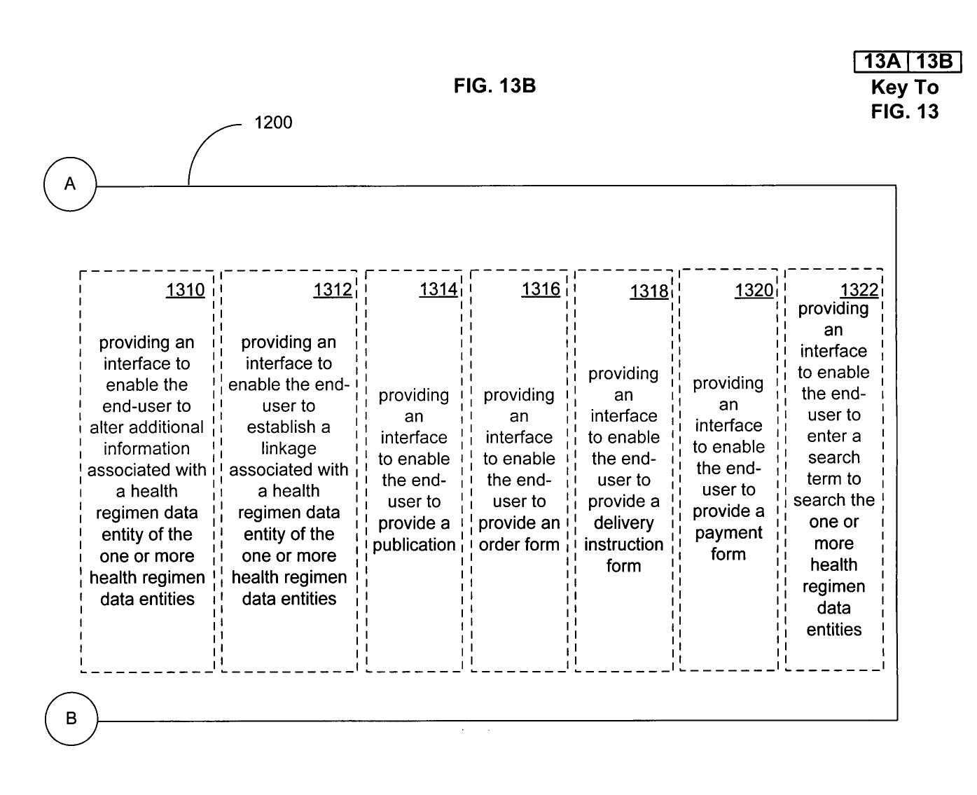

FIG. 13 shows several alternative implementations of the high-level logic flowchart of FIG. 12. Operation 1200—providing an interface to enable an end-user to change one or more health regimen data entities—may include one or more of the following operations: 1300, 1302, 1304, 1306, 1308, 1310, 1312, 1314, 1316, 1318, 1320, and/or 1322. Operation 1300 depicts providing an interface to enable the end-user to add a health regimen data entity to the one or more health regimen data entities (e.g., providing an interface via the end-user interface device 104, using the end-user logic 106, by which the end-user 102 may add a health regimen data entity to a data structure stored at least in part on the computer 108). Operation 1302 shows providing an interface to enable the end-user to delete a health regimen data entity from the one or more health regimen data entities (e.g., providing an interface via the end-user interface device 104, using the end-user logic 106, by which the end-user 102 may delete a health regimen data entity from a data structure stored at least in part on the computer 108). Operation 1304 illustrates providing an interface to enable the end-user to alter a health regimen data entity of the one or more health regimen data entities (e.g., providing an interface via the end-user interface device 104, using the end-user logic 106, by which the end-user 102 may alter a health regimen data entity that is part of a data structure stored at least in part on the computer 108). Operation 1306 depicts providing an interface to enable the end-user to add additional information to a health regimen data entity of the one or more health regimen data entities (e.g., providing an interface via the end-user interface device 104, using the end-use logic 106, by which the end-use 102 may add additional information to a health regimen data entity that is part of a data structure stored at least in part on the computer 108). Operation 1308 illustrates providing an interface to enable the end-user to delete additional information from a health regimen data entity of the one or more health regimen data entities (e.g., providing an interface via the end-user interface device 104, using the end-use logic 106, by which the end-use 102 may delete additional information from a health regimen data entity that is part of a data structure stored at least in part on the computer 108). Operation 1310 shows providing an interface to enable the end-user to alter additional information associated with a health regimen data entity of the one or more health regimen data entities (e.g., providing an interface via the end-user interface device 104, using the end-use logic 106, by which the end-use 102 may alter additional information associated with a health regimen data entity that is part of a data structure stored at least in part on the computer 108). Operation 1312 illustrates providing an interface to enable the end-user to establish a linkage associated with a health regimen data entity of the one or more health regimen data entities (e.g., providing an interface via the end-user interface device 104, using the end-use logic 106, by which the end-user 102 may establish, e.g., change, a linkage associated with a health regimen data entity of the one or more health regimen data entities that are part of a data structure stored at least in part on the computer 108). Operation 1314 shows providing an interface to enable the end-user to provide a publication (e.g., providing an interface via the end-user interface device 104 and the computer 108, using the end-user logic 106, by which the end-user 102 may provide an order form for accepting orders for products and/or services such as nutraceutical substances or procedures). Operation 1316 depicts providing an interface to enable the end-user to provide an order form (e.g., providing an interface via the end-user interface device 104 and the computer 118, using the end-user logic 106, by which the end-user 102 may provide a payment form for accepting payment for products and/or services such as dietary substances or procedures). Operation 1318 illustrates providing an interface to enable the end-user to provide a delivery instruction form (e.g., providing an interface via the end-user interface device 104 and the computer 108, using the end-user logic 106, by which the end-user 102 may provide a delivery instruction form for accepting delivery instructions for products and/or services such as veterinary substances or procedure). Operation 1320 depicts providing an interface to enable the end-user to provide a payment form (e.g., providing an interface via the end-user interface device 104 and the computer 108, using the end-user logic 106, by which the end-user 102 may provide a payment form for accepting payment from another end-user and/or a vendors and/or a publisher). Operation 1322 depicts providing an interface to enable the end-user to enter a search term to search the one or more health regimen data entities (e.g., providing an interface via the end-user interface device 104 and the computer 108, using the end-user logic 106, by which the end-user 102 may enter a search term to search the one or more health regimen data entities, such as the search term “lithium”).

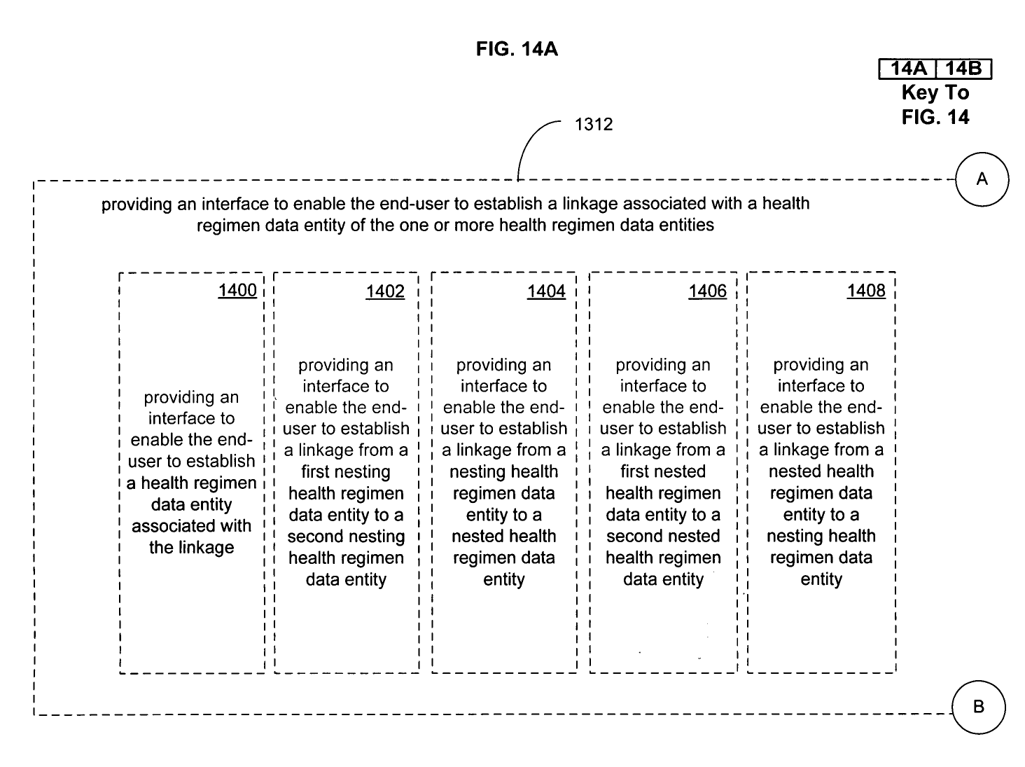

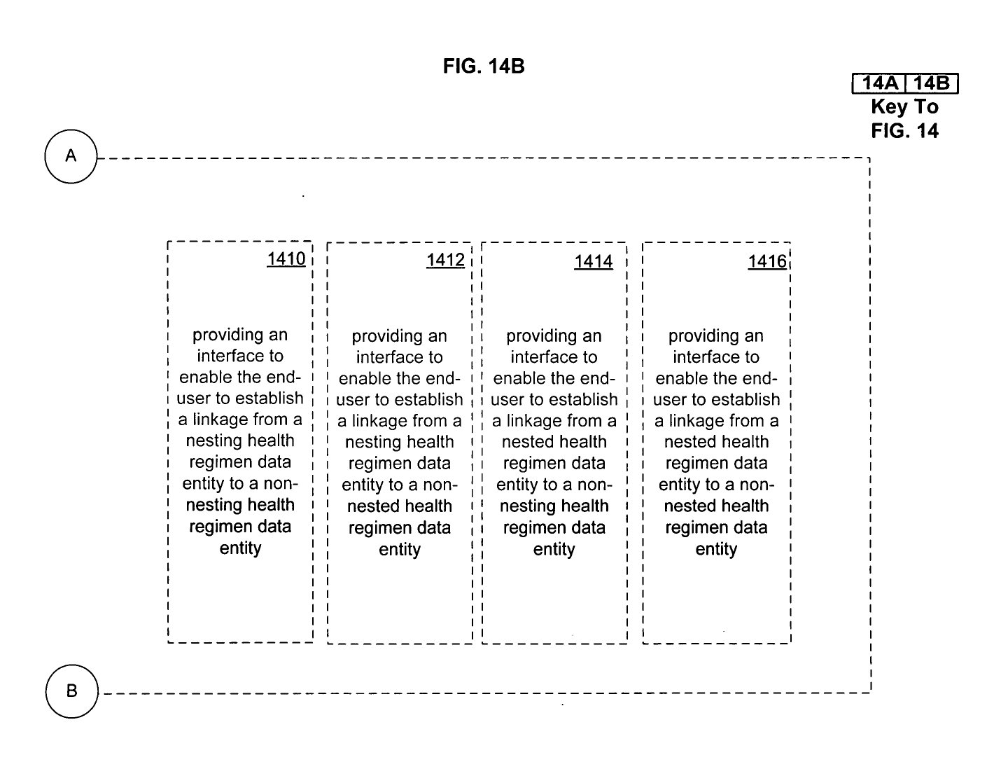

FIG. 14 shows several alternative implementations of the high-level logic flowchart of FIG. 13. Operation 1312—providing an interface to enable the end-user to establish a linkage associated with a health regimen data entity of the one or more health regimen data entities—may include one or more of the following operations: 1400, 1402, 1404, 1406, 1408, 1410, 1412, 1414, and/or 1416. Operation 1400 shows providing an interface to enable the end-user to establish a health regimen data entity associated with the linkage (e.g., providing an interface via the end-user interface device 104, using the end-user logic 106, by which the end-user 102 may establish, e.g., add and/or select, a health regimen data entity, such as the health regimen data entity 304 associated with the linkage 310, that are parts of a data structure that is stored at least in part on the computer 108). Operation 1402 depicts providing an interface to enable the end-user to establish a linkage from a first nesting health regimen data entity to a second nesting health regimen data entity (e.g., providing an interface via the end-user interface device 104, using the end-user logic 106, by which the end-user 102 may establish, e.g., select, a linkage 418 from a first nesting health regimen data entity, such as personal notes about usage 306, to a second nesting health regimen data entity, such as Brand Y vitamin regimen 408, that are parts of a data structure that is stored at least in part on the computer 108). Operation 1404 illustrates providing an interface to enable the end-user to establish a linkage from a nesting health regimen data entity to a nested health regimen data entity (e.g., providing an interface via the end-user interface device 104, using the end-user logic 106, by which the end-user 102 may establish, e.g., select, a linkage from a nesting health regimen data entity, such as an identifier for lithium 204, to a nested health regimen data entity, such as a health regimen data entity 206 comprising indications, cautions, and research associated with lithium, that are parts of a data structure that is stored at least in part on the computer 108). Operation 1406 illustrates providing an interface to enable the end-user to establish a linkage from a first nested health regimen data entity to a second nested health regimen data entity (e.g., providing an interface via the end-user interface device 104, using the end-user logic 106, by which the end-user 102 may establish, e.g., select, a linkage 428 from a first nesting health regimen data entity, such personal notes 314 regarding usage of a substance, to a second nested health regimen data entity, such as a constituent 416 in a vitamin regimen, that are parts of a data structure that is stored at least in part on the computer 108). Operation 1408 depicts providing an interface to enable the end-user to establish a linkage from a nested health regimen data entity to a nesting health regimen data entity (e.g., providing an interface via the end-user interface device 104, using the end-user logic 106, by which the end-user 102 may establish, e.g., select, a linkage 430 from a nested health regimen data entity, such as a personal note 314 regarding usage of a substance, to a nesting health regimen data entity, such as a vitamin regimen 408, that are parts of a data structure that is stored at least in part on the computer 108). Operation 1410 depicts providing an interface to enable the end-user to establish a linkage from a nesting health regimen data entity to a non-nesting health regimen data entity (e.g., providing an interface via the end-user interface device 104, using the end-user logic 106, by which the end-user 102 may establish, e.g., select, a linkage 216 from a nesting health regimen data entity, such as a health regimen data entity 212 comprising indications, cautions, and research information associated with lithium, to a non-nesting health regimen data entity, such as a health regimen data entity 218 comprising an identifier for lithium, that are parts of a data structure that is stored at least in part on the computer 108). Operation 1412 shows providing an interface to enable the end-user to establish a linkage from a nesting health regimen data entity to a non-nested health regimen data entity (e.g., providing an interface via the end-user interface device 104, using the end-user logic 106, by which the end-user 102 may establish, e.g., select, a linkage 310 from a nesting health regimen data entity, such as a health regimen data entity 306 comprising personal notes regarding usage of lithium, to a non-nested health regimen data entity, such as a health regimen data entity 304 comprising an identifier for lithium, that are parts of a data structure that is stored at least in part on the computer 108). Operation 1414 depicts providing an interface to enable the end-user to establish a linkage from a nested health regimen data entity to a non-nesting health regimen data entity (e.g., providing an interface via the end-user interface device 104, using the end-user logic 106, by which the end-user 102 may establish, e.g., select, a linkage from a nested health regimen data entity, such as a health regimen data entity 212 comprising indications, cautions, and research associated with lithium, to a non-nesting health regimen data entity, such as a health regimen data entity 214 comprising an indication of depression, that are parts of a data structure that is stored at least in part on the computer 108). Operation 1416 depicts providing an interface to enable the end-user to establish a linkage from a nested health regimen data entity to a non-nested health regimen data entity (e.g., providing an interface via the end-user interface device 104, using the end-user logic 106, by which the end-user 102 may establish, e.g., select, a linkage 310 from a nested health regimen data entity, such as a health regimen data entity 312 comprising a personal note regarding the usage of lithium, to a non-nested health regimen data entity, such as a health regimen data entity 304 comprising an identifier for lithium, that are parts of a data structure that is stored at least in part on the computer 108).

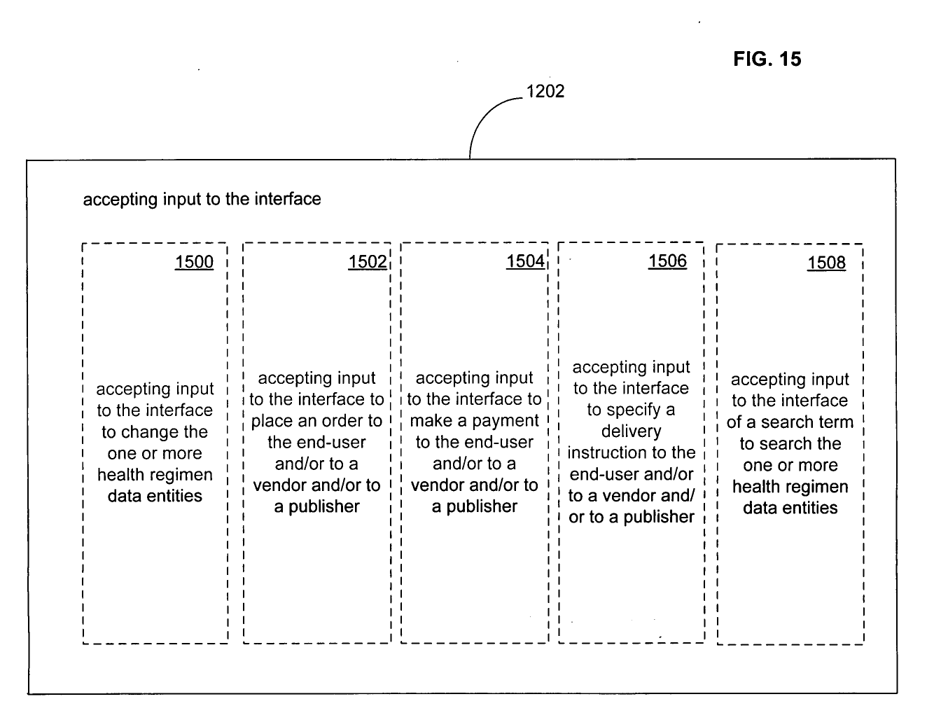

FIG. 15 depicts several alternative implementations of the high-level logic flowchart of FIG. 12. Operation 1202—accepting input to the interface—may include one or more of the following operations: 1500, 1502, 1504, 1506, and/or 1508.

Operation 1500 shows accepting input to the interface to change the one or more health regimen data entities (e.g., accepting input via the end-user interface device 104, using the end-user logic 106 of the computer 108, by which the end-user 102 may add and/or delete and/or alter a health regimen data entity that is part of a data structure that is stored on the computer 108). Operation 1502 depicts accepting input to the interface to place an order to the end-user and/or to a vendor and/or to a publisher (e.g., accepting input via the computer 108, using the end-user logic 106 of the computer 108, by which an order for a substance and/or a procedure and/or a publication may be placed to an end-user 102 and/or to a vendor 112 and/or to a publisher 120). Operation 1504 illustrates accepting input to the interface to make a payment to the end-user and/or to a vendor and/or to a publisher (e.g., accepting input via the computer 108, using the end-user logic 106 of the computer 108, by which a payment for a substance and/or a procedure and/or a publication may be placed to an end-user 102 and/or to a vendor 112 and/or to a publisher 120). Operation 1506 shows accepting input to the interface to specify a delivery instruction to the end-user and/or to a vendor and/or to a publisher (e.g., accepting input via the computer 108, using the end-user logic 106 of the computer 108, by which delivery instructions for a substance and/or a procedure and/or a publication may be placed to an end-user 102 and/or to a vendor 112 and/or to a publisher 120). Operation 1508 shows accepting input to the interface of a search term to search the one or more health regimen data entities (e.g., accepting input via the computer 108, using the end-user logic 106 of the computer 108, by which a search term such as “lithium” may be accepted from an end-user 102).

Those having skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies equally regardless of the particular type of signal bearing media used to actually carry out the distribution. Examples of a signal bearing media include, but are not limited to, the following: recordable type media such as floppy disks, hard disk drives, CD ROMs, digital tape, and computer memory; and transmission type media such as digital and analog communication links using TDM or IP based communication links (e.g., packet links).

In a general sense, those skilled in the art will recognize that the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment).

Those skilled in the art will recognize that it is common within the art to describe devices and/or processes in the fashion set forth herein, and thereafter use engineering practices to integrate such described devices and/or processes into image processing systems. That is, at least a portion of the devices and/or processes described herein can be integrated into an image processing system via a reasonable amount of experimentation. Those having skill in the art will recognize that a typical image processing system generally includes one or more of a system unit housing, a video display device, a memory such as volatile and non-volatile memory, processors such as microprocessors and digital signal processors, computational entities such as operating systems, drivers, and applications programs, one or more interaction devices, such as a touch pad or screen, control systems including feedback loops and control motors (e.g., feedback for sensing lens position and/or velocity; control motors for moving/distorting lenses to give desired focuses. A typical image processing system may be implemented utilizing any suitable commercially available components, such as those typically found in digital still systems and/or digital motion systems.

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

All of the above U.S. patents, U.S. patent application publications, U.S. patent applications, foreign patents, foreign patent applications and non-patent publications referred to in this specification and/or listed in any Application Data Sheet, are incorporated herein by reference, in their entireties.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of this subject matter described herein. Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.).

We claim:

1. A method related to health-related data management, the method comprising:
providing an interface to enable an end-user to change one or more health regimen data entities; and
accepting input to the interface.

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. A system related to health-related data management, the system comprising:
circuitry for providing an interface to enable an end-user to change one or more health regimen data entities; and
circuitry for accepting input to the interface.

29. A system related to health-related data management, the system comprising:
means for providing an interface to enable an end-user to change one or more health regimen data entities; and
means for accepting input to the interface.

30. A program product, comprising:
a signal-bearing medium bearing one or more instructions for providing an interface to enable an end-user to change one or more health regimen data entities; and
one or more instructions for accepting input to the interface.

31. (canceled)

32. (canceled)

33. The program product of claim 30, wherein the one or more instructions for providing an interface to enable an end-user to change one or more health regimen data entities further comprise:
one or more instructions for providing an interface to enable the end-user to add a health regimen data entity to the one or more health regimen data entities.

34. The program product of claim 30, wherein the one or more instructions for providing an interface to enable an end-user to change one or more health regimen data entities further comprise:
one or more instructions for providing an interface to enable the end-user to delete a health regimen data entity from the one or more health regimen data entities.

35. The program product of claim 30, wherein the one or more instructions for providing an interface to enable an end-user to change one or more health regimen data entities further comprise:
one or more instructions for providing an interface to enable the end-user to alter a health regimen data entity of the one or more health regimen data entities.

36. The program product of claim 30, wherein the one or more instructions for providing an interface to enable an end-user to change one or more health regimen data entities further comprise:
one or more instructions for providing an interface to enable the end-user to add additional information to a health regimen data entity of the one or more health regimen data entities.

37. The program product of claim 30, wherein the one or more instructions for providing an interface to enable an end-user to change one or more health regimen data entities further comprise:
one or more instructions for providing an interface to enable the end-user to delete additional information from a health regimen data entity of the one or more health regimen data entities.

38. The program product of claim 30, wherein the one or more instructions for providing an interface to enable an end-user to change one or more health regimen data entities further comprise:
one or more instructions for providing an interface to enable the end-user to alter additional information associated with a health regimen data entity of the one or more health regimen data entities.

39. The program product of claim 30, wherein the one or more instructions for providing an interface to enable an end-user to change one or more health regimen data entities further comprise:
one or more instructions for providing an interface to enable the end-user to establish a linkage associated with a health regimen data entity of the one or more health regimen data entities.

40. The program product of claim 39, wherein the one or more instructions for providing an interface to enable the end-user to establish a linkage associated with a health regimen data entity of the one or more health regimen data entities further comprise:
one or more instructions for providing an interface to enable the end-user to establish a health regimen data entity associated with the linkage.

41. The program product of claim 39, wherein the one or more instructions for providing an interface to enable the end-user to establish a linkage associated with a health regimen data entity of the one or more health regimen data entities further comprise:
one or more instructions for providing an interface to enable the end-user to establish a linkage from a first nesting health regimen data entity to a second nesting health regimen data entity.

42. The program product of claim 39, wherein the one or more instructions for providing an interface to enable the end-user to establish a linkage associated with a health regimen data entity of the one or more health regimen data entities further comprise:
one or more instructions for providing an interface to enable the end-user to establish a linkage from a nesting health regimen data entity to a nested health regimen data entity.

43. The program product of claim 39, wherein the one or more instructions for providing an interface to enable the end-user to establish a linkage associated with a health regimen data entity of the one or more health regimen data entities further comprise:
one or more instructions for providing an interface to enable the end-user to establish a linkage from a first nested health regimen data entity to a second nested health regimen data entity.

44. The program product of claim 39, wherein the one or more instructions for providing an interface to enable the end-user to establish a linkage associated with a health regimen data entity of the one or more health regimen data entities further comprise:
one or more instructions for providing an interface to enable the end-user to establish a linkage from a nested health regimen data entity to a nesting health regimen data entity.

45. The program product of claim 39, wherein the one or more instructions for providing an interface to enable the end-user to establish a linkage associated with a health regimen data entity of the one or more health regimen data entities further comprise:
one or more instructions for providing an interface to enable the end-user to establish a linkage from a nesting health regimen data entity to a non-nesting health regimen data entity.

46. The program product of claim 39, wherein the one or more instructions for providing an interface to enable the end-user to establish a linkage associated with a health regimen data entity of the one or more health regimen data entities further comprise:
one or more instructions for providing an interface to enable the end-user to establish a linkage from a nesting health regimen data entity to a non-nested health regimen data entity.

47. The program product of claim 39, wherein the one or more instructions for providing an interface to enable the end-user to establish a linkage associated with a health regimen data entity of the one or more health regimen data entities further comprise:
one or more instructions for providing an interface to enable the end-user to establish a linkage from a nested health regimen data entity to a non-nesting health regimen data entity.

48. The program product of claim 39, wherein the one or more instructions for providing an interface to enable the end-user to establish a linkage associated with a health regimen data entity of the one or more health regimen data entities further comprise:
one or more instructions for providing an interface to enable the end-user to establish a linkage from a nested health regimen data entity to a non-nested health regimen data entity.

49. The program product of claim 30, wherein the one or more instructions for providing an interface to enable an end-user to change one or more health regimen data entities further comprise:
one or more instructions for providing an interface to enable the end-user to provide a publication.

50. The program product of claim 30, wherein the one or more instructions for providing an interface to enable an end-user to change one or more health regimen data entities further comprise:
one or more instructions for providing an interface to enable the end-user to provide an order form.

51. The program product of claim 30, wherein the one or more instructions for providing an interface to enable an end-user to change one or more health regimen data entities further comprise:
one or more instructions for providing an interface to enable the end-user to provide a delivery instruction form.

52. The program product of claim 30, wherein the the one or more instructions for providing an interface to enable an end-user to change one or more health regimen data entities further comprise:
the one or more instructions for providing an interface to enable the end-user to provide a payment form.

53. The program product of claim 30, wherein the one or more instructions for providing an interface to enable an end-user to change one or more health regimen data entities further comprise:
one or more instructions for providing an interface to enable the end-user to enter a search term to search the one or more health regimen data entities.

54. The program product of claim 30, wherein the one or more instructions for accepting input to the interface further comprise:
one or more instructions for accepting input to the interface to change the one or more health regimen data entities.

55. The program product of claim 30, wherein the one or more instructions for accepting input to the interface further comprise:
one or more instructions for accepting input to the interface to place an order to the end-user and/or to a vendor and/or to a publisher.

56. The program product of claim 30, wherein the one or more instructions for accepting input to the interface further comprise:
one or more instructions for accepting input to the interface to make a payment to the end-user and/or to a vendor and/or to a publisher.

57. The program product of claim 30, wherein the one or more instructions for accepting input to the interface further comprise:
one or more instructions for accepting input to the interface to specify a delivery instruction to the end-user and/or to a vendor and/or to a publisher.

58. The program product of claim 30, wherein the one or more instructions for accepting input to the interface further comprise: one or more instructions for accepting input to the interface of a search term to search the one or more health regimen data entities.
